(19) United States
(12) Patent Application Publication
(10) Pub. No.: US 2026/0135669 A1
(43) Pub. Date: May 14, 2026

(54) DATA TRANSMISSION METHOD, TERMINAL DEVICE AND NETWORK DEVICE

(71) Applicant: QUECTEL WIRELESS SOLUTIONS CO., LTD., Shanghai (CN)

(72) Inventor: Qufang HUANG, Shanghai (CN)

(21) Appl. No.: 19/444,093

(22) Filed: Jan. 8, 2026

Related U.S. Application Data
(63) Continuation of application No. PCT/CN2023/138683, filed on Dec. 14, 2023.

(51) Int. Cl. H04L 5/00; H04L 1/1867

(52) U.S. Cl. CPC H04L 5/0053; H04L 1/1896

(57) ABSTRACT

A data transmission method, a terminal device and a network device are provided. One example method includes: acquiring, by a terminal device, first information. The first information is configured to instruct the terminal device to perform a first processing on first data, the first data is first-type data, and the first processing includes: transmitting a portion of the first data, and/or, not performing retransmission on the first data.

### CROSS-REFERENCE TO RELATED APPLICATIONS

This application is a continuation of International Application No. PCT/CN 2023/138683, filed on Dec. 14, 2023, the disclosure of which is hereby incorporated by reference in its entirety.

### TECHNICAL FIELD

Various embodiments described in this documents relate to the technical field of communication, and in particular to a data transmission method, a terminal device and a network device.

### BACKGROUND

Some types of data, such as extended reality (XR) service data, generally need to be transmitted in cooperation with uplink and downlink. A server can generate downlink feedback according to the latest uplink data to improve the user experience. In order to ensure that the server always has the latest uplink data available, the uplink data generally has a relatively high sampling frequency. Therefore, how to improve the transmission performance of the type of data is a problem to be solved.

### SUMMARY

A data transmission method, a terminal device and a network device are provided according to some embodiments of the present disclosure. Various aspects involved in the embodiments of the present disclosure are described below.

In a first aspect, a data transmission method is provided. The method includes acquiring, by a terminal device, first information. The first information is configured to instruct the terminal device to perform a first processing on first data, the first data is first-type data, and the first processing includes: transmitting a portion of the first data, and/or not performing retransmission on the first data.

In a second aspect, a data transmission method is provided. The method includes transmitting, by a network device, first information to a terminal device. The first information is configured to instruct the terminal device to perform a first processing on first data, the first data is first-type data, and the first processing includes: transmitting a portion of the first data, and/or not performing retransmission on the first data.

In a third aspect, a terminal device is provided. The terminal device includes an acquisition unit, configured to receive first information transmitted by a network device. The first information is configured to instruct the terminal device to perform a first processing on first data, and the first data is first-type data, and the first processing includes: transmitting a portion of the first data, and/or not performing retransmission on the first data.

In a fourth aspect, a network device is provided. The network device includes: a first transmitting unit, configured to transmit first information to a terminal device. The first information is configured to instruct the terminal device to perform a first processing on first data, the first data is first-type data, and the first processing includes: transmitting a portion of the first data, and/or not performing retransmission on the first data.

In a fifth aspect, a terminal device is provided. The terminal device includes a memory, a processor and a communication interface. The memory is configured to store one or more computer programs, and the processor is configured to call the one or more computer programs in the memory to implement a portion or all of operations in the method according to the first aspect.

In a sixth aspect, a network device is provided. The network device includes a memory, a processor and a communication interface. The memory is configured to store one or more computer programs, and the processor is configured to call the one or more computer programs in the memory to implement a portion or all of operations in the method according to the second aspect.

In a seventh aspect, a communication system is provided according to some embodiments of the present disclosure, and includes the terminal device and/or the network device. In another possible design, the communication system further includes other devices that interact with the terminal device or the network device according to the embodiments of the present disclosure.

In an eighth aspect, a computer-readable storage medium is provided according to some embodiments of the present disclosure. A computer program is stored on the computer-readable storage medium, to cause a terminal device to implement a portion or all of operations in the method according to the first aspect or the second aspect.

In a ninth aspect, a computer program product is provided according to some embodiments of the present disclosure. The computer program product includes a non-transitory computer-readable storage medium storing a computer program operable to cause a terminal device to implement a portion or all of operations in the method according to the first aspect or the second aspect. In some implementations, the computer program product is a software installation package.

In a tenth aspect, a chip is provided according to some embodiments of the present disclosure. The chip includes a memory and a processor, and the processor is configured to call a computer program in the memory to implement a portion or all of operations in the method according to the first aspect or the second aspect.

In the embodiments of the present disclosure, the terminal device can perform the first processing on the first-type data, such as the first data, including not retransmitting the first data, and/or transmitting the portion of the first data. Since the network device may have received the updated first-type data in response to receiving the retransmitted data, the retransmitted data is invalid. Therefore, not retransmitting the first-type data is beneficial to avoiding the transmission of invalid data, thereby reducing the uplink load of the network and further improving the system performance. In addition, transmitting only the portion of the first data, or preferentially transmitting the portion of the first data, such as data with a large amount of information and data with high priority, which is beneficial to reducing the uplink load of the network.

### BRIEF DESCRIPTION OF THE DRAWINGS

FIG. 1 is a schematic diagram of a wireless communication system applied to some embodiments of the present disclosure.

FIG. 2 is an example diagram of uplink transmission and downlink transmission of haptic data.

FIG. 3 is an example diagram of retransmission of haptic data.

FIG. 4 is a schematic flowchart of a data transmission method provided by some embodiments of the present disclosure.

FIG. 5 is a schematic structural diagram of a terminal device provided by some embodiments of the present disclosure.

FIG. 6 is a schematic structural diagram of a network device provided by some embodiments of the present disclosure.

FIG. 7 is a schematic structural diagram of a device provided by some embodiments of the present disclosure.

### DETAILED DESCRIPTION OF THE EMBODIMENTS

The technical solutions in the embodiments of the present disclosure will be described below in conjunction with the accompanying drawings.

### Communication System

FIG. 1 is a wireless communication system 100 applied to the embodiments of the present disclosure. The wireless communication system 100 may include communication devices. The communication devices may include a network device 110 and a terminal device 120. The network device 110 may be a device in communication with the terminal device 120

FIG. 1 exemplarily shows one network device and two terminal devices. In some embodiments of the present disclosure, the wireless communication system 100 may include multiple network devices, and the coverage area of each network device may include terminal devices with other number, which is not limited by the embodiments of the present disclosure.

In addition, the wireless communication system 100 may further include other network entities such as a network controller and a mobility management entity, which is not limited by the embodiments of the present disclosure.

It should be noted that the technical solutions according to the embodiments of the present disclosure may be applied to various communication systems, for example, a 5th-generation (5G) system, a new radio (NR) system, a long term evolution (LTE) system, a LTE frequency division duplex (FDD) system, and a LTE time division duplex (TDD) system. The technical solutions according to the embodiments of the present disclosure may be applied to a future communication system, for example, a 6th-generation (6G) mobile communication system, or a satellite communication system.

The terminal device mentioned in the embodiments of the present disclosure may also be referred to as user equipment (UE), access terminal, user unit, user station, mobile station (MS), mobile terminal (MT), remote station, remote terminal, mobile device, user terminal, terminal device, wireless communication device, user agent or user device, etc. In some embodiments, the terminal device may be a device that provides voice and/or data connectivity to a user, and may be configured to connect people, things and machines, such as a handheld device and a vehicle-mounted device with wireless connection function. The terminal device may be a mobile phone, a tablet computer (Pad), a notebook computer, a personal digital assistant, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, and a wireless terminal in smart home, etc. In some embodiments, the UE may act as a base station. For example, the UE may act as a scheduling entity, which provides a sidelink signal between UEs in vehicle-to-everything (V2X) or device-to-device (D2D), etc. For example, a cellular phone and a car communicate with each other using sidelink signals. A cellular phone and a smart home device communicate with each other without relaying communication signals through a base station.

The network device in the embodiments of the present disclosure is a device for communicating with the terminal device. The network device includes an access network device. The access network device may provide communication coverage for a specific geographical area and may communicate with terminal devices 120 located in the coverage area. The access network device may be referred to as a wireless access network device or a base station. The access network device in the embodiments of the present disclosure may refer to a radio access network (RAN) node (or device) that connects the terminal device to the wireless network. The access network device may broadly cover various names as follows, or may be replaced with the following names, such as: NodeB, evolved NodeB (eNB), next generation NodeB (gNB), relay station, access point, transmitting and receiving point (TRP), transmitting point (TP), master evolved NodeB (MeNB), secondary evolved NodeB (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node, etc. The base station may be a macro base station, a micro base station, a relay node, a donor node, or the like, or a combination thereof. The base station may also refer to a communication module, a modem, or a chip installed in the aforementioned device or equipment. The base station may also be a mobile switching center, a device that undertakes the functions of a base station in device-to-device (D2D), vehicle-to-everything (V2X), machine-to-machine (M2M) communications, a network-side device in a 6G network, and a device that undertakes the functions of a base station in a future communication system, etc. The base station may support networks with the same or different access technologies. The embodiments of the present disclosure do not limit the specific technology and specific device form adopted by the access network device.

The base station may be fixed or mobile. For example, a helicopter or an unmanned aerial vehicle may be configured as a mobile base station, and one or more cells may move according to the position of the mobile base station. In other examples, a helicopter or an unmanned aerial vehicle may be configured as a device to communicate with another base station.

The communication device involved in the wireless communication system may include not only the access network device and the terminal device, but also a core network element. The core network element may be realized by a device, that is, the core network element is a core network device. It should be understood that the core network device may also be a network device.

The core network element in the embodiments of the present disclosure may include a network element that processes and forwards the signaling and data of users. For example, the core network device may include core network access and mobility management function (AMF), session management function (SMF), user plane gateway, location management function (LMF) and other core network devices. The user plane gateway may be a server with the functions of mobility management, routing and forwarding of user plane data, and is generally located on the network side, such as a serving gateway (SGW) or a packet data network gateway (PGW) or a user plane function (UPF). Alternatively, the core network may also include other network elements, which are not listed herein.

In some examples, the network device according to the embodiments of the present disclosure may be CU or DU, or the network device may include both CU and DU. Alternatively, gNB may further include AAU.

The network device and the terminal device may be deployed on land, including indoors or outdoors, handheld or vehicle-mounted. The network device and the terminal device may be deployed on the water surface. The network device and the terminal device may be deployed on an aircraft, a balloon, or a satellite in the air. The scenarios where the network devices and the terminal devices are located are not limited by the embodiments of the present disclosure.

It should be understood that all or part of the functions of the communication device in the embodiments of the present disclosure may also be implemented by software functions running on hardware, or by virtualization functions instantiated on a platform (such as a cloud platform).

When a cellular wireless network transmits some types of data, such as XR service data, especially interactive service data, it needs to transmit in cooperation with uplink and downlink. For example, user operation actions are transmitted in the uplink, and data such as video and audio generated by the XR application server are transmitted in the downlink. In the related art, the user operation of uplink transmission mainly includes: position, height and moving speed of the user, the action of the operating handle of the user, etc. With the development of technology, XR service has introduced haptic-based service, such as fine operation for remote surgery.

For users, if the total delay of uplink transmission and downlink transmission is less than tens of milliseconds, a perfect interactive experience can be achieved. Based on this, the server can generate downlink feedback according to the latest uplink data, so as to improve the user experience.

In order to ensure that the server always has the latest uplink data available, the uplink data generally has a relatively high sampling frequency. For example, the sampling frequency and updating frequency of data related to the position, height, and moving speed of the user and the action of the operating handle of the user reach tens of milliseconds. Since haptic data involves the fine feelings of human body, its sampling frequency is much higher than the sampling frequency of ordinary operating handle, reaching 1000 times per second.

Taking haptic data as an example, in order to ensure that a duration from sending sampled haptic data by a user to receiving corresponding downlink feedback is short enough, the server generally generates downlink feedback according to the latest uplink haptic data. For example, at the moment of generating the downlink feedback, the server selects the latest (i.e., the latest generated) uplink haptic data from the received uplink haptic data, and generates the downlink feedback based on the latest haptic data. Therefore, the reason why the client adopts high-frequency sampling of haptic data is to ensure that the server always has the latest uplink haptic data available.

In this case, how to improve the transmission performance of the kind of data is a problem to be solved. Haptic data is taken as an example below to describe the possible problems in the transmission of the kind of data.

### Effective Transmission of Haptic Data

For wired networks, every sampled haptic data is transmitted in real time, so the above design (that is, high-frequency sampling for the haptic data) is effective. However, for wireless networks, if all the sampled haptic data are transmitted to the server, the cellular wireless networks need to transmit a sampling result in every subframe, which consumes a lot of wireless resources. In order to save wireless resources, in the related art, the terminal device transmits a plurality of sampled haptic data to the XR server at one time. However, as mentioned above, after receiving a plurality of haptic data, the XR server only generates downlink feedback according to the latest sampled data to ensure the user experience. That is, only a portion of the haptic data transmitted to the XR server at one time are valid, and the transmission of other data is actually invalid.

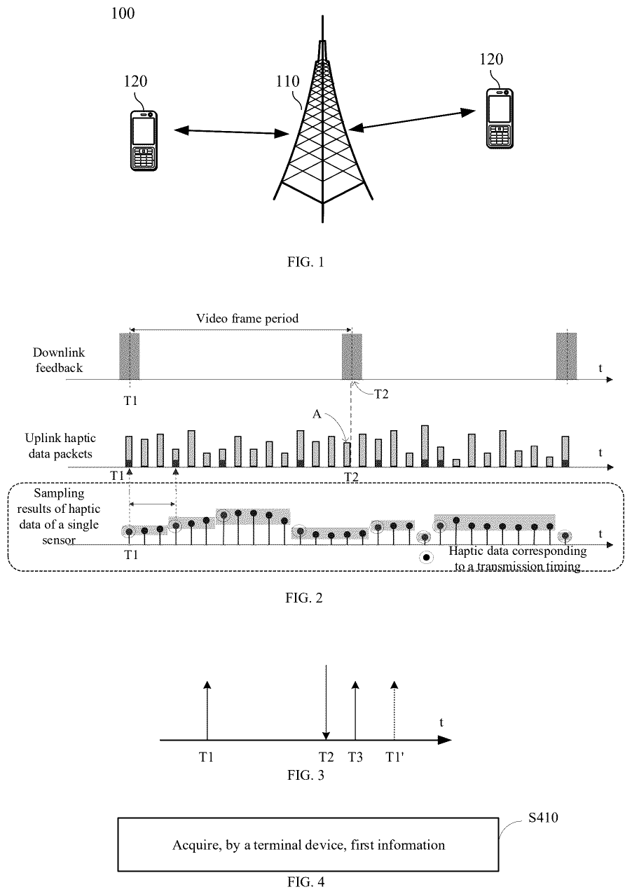

FIG. 2 is an example diagram of uplink transmission and downlink transmission of haptic data. FIG. 2 shows sampling results of haptic data of a single sensor, uplink haptic data packets, and downlink feedback (such as video frames) of the network device for haptic data.

Referring to FIG. 2, among the sampling results of haptic signals of the single sensor, some sampled data correspond to the transmission timings of haptic data, and some sampling data do not correspond to the transmission timings of haptic data. In some embodiments, transmission timings of the haptic data may be determined based on difference of the haptic data. For example, when the difference between current haptic data and previously obtained haptic data is greater than a certain threshold, the current haptic data corresponds to a transmission timing of the haptic data. At the transmission timing of the haptic data, the terminal device may transmit a plurality of haptic data to the network device.

Referring to. 2, the uplink haptic data packet may include the sampling results of a plurality of haptic sensors. After receiving the uplink haptic data, the network device may generate downlink feedback, such as generating downlink feedback based on the latest haptic data. Taking moment T2 as an example, the network device may select the latest (recently generated) uplink haptic data packet A from the haptic data packets transmitted in the uplink between moment T1 and moment T2, and generate a video frame for downlink feedback based on the data packet A.

### Retransmission of Haptic Data

In order to ensure the reliability of data transmission, a retransmission mechanism, such as hybrid automatic repeat-request (HARQ) retransmission mechanism, is introduced into the wireless communication system. Based on the HARQ retransmission mechanism, if a piece of uplink haptic data transmits unsuccessfully, the network device may schedule the terminal device for retransmission. However, as mentioned above, the downlink feedback is always generated based on the latest haptic data. If the network device has received new haptic data before receiving the retransmitted haptic data, the network device generates downlink feedback based on the received new haptic data, that is, the retransmitted haptic data is invalid or useless to the network device. As shown in FIG. 3, the terminal device transmits a piece of haptic data at moment T1, but the base station fails to decode it, and the terminal device is scheduled to retransmit the haptic data at moment T2. The terminal device retransmits the haptic data at moment T1′. However, since the terminal device has already transmitted the updated haptic data at moment T3, even if the retransmitted haptic data at T1′ is successfully transmitted, the retransmitted haptic data is useless to the server.

### Encoding Mode of Haptic Data

Before transmitting the haptic data, encoding is generally required for the haptic data. In some embodiments, the terminal device may encode the haptic data in a cumulative manner, which may also be referred to as differential encoding. Differential encoding means that when the current data packet is encoded, encoding is performed according to the difference between the current data packet and the previous data packet. For example, when the Nth data packet is encoded, encoding is performed based on the data difference between the Nth data packet and the (N-1)th data packet. For example, the Nth data packet may indicate that the leftward force is increased by 1 Newton on the basis of the (N-1)th data packet. In this case, if the network device does not receive the previously transmitted (N-1)th data packet, it will lead to the misunderstanding of the Nth data packet.

In order to solve one or more of the above problems, a data transmission method is provided according to some embodiments of the present disclosure, which is beneficial to reducing the uplink load of the network by performing the first processing on the first-type data (i.e., the first data), such as not retransmitting the first data, and/or transmitting a portion of the first data, thereby improving the system performance.

FIG. 4 is a flowchart of a data transmission method provided by some embodiments of the present disclosure. The method provided by the embodiments of the present disclosure will be described with reference to FIG. 4.

The method shown in FIG. 4 includes operation S410. In S410, a terminal device acquires first information.

The first information is configured to instruct the terminal device to perform the first processing on the first data. The first data is first-type data. The first-type data may be “meaningless retransmission” service data. The “meaningless retransmission” service or data mentioned herein may be understood as that the retransmitted data is useless to the system for the kind of service, or that the system may not use the retransmitted data of the kind of service. For example, the first-type data is data with relatively high sampling frequency, and the downlink feedback is data generated based on the latest first-type data. As an example, the first-type data is haptic data.

In some embodiments, the first processing described above may include not performing retransmission on the first data. As mentioned above, when the network device receives the retransmitted data, it may have received the updated data, so the retransmitted data is invalid. Therefore, not performing retransmission on the first data is beneficial to avoiding the transmission of invalid data, thereby improving the system performance and saving transmission resources.

In some embodiments, the first processing may include transmitting a portion of the first data (which may be referred to as second data), such as transmitting only the second data, or preferentially transmitting the second data. The uplink load of the network can be reduced by transmitting the portion of the first data. For example, the second data may refer to the data with a large amount of information and the data with high priority included in the first data, which is beneficial to reducing the uplink load of the network on the basis of ensuring the user experience. The related information of the second data will be described with specific examples below, which will not be repeated herein.

In some embodiments, the first processing includes transmitting the portion of the first data and not performing retransmission on the first data. In this case, the first information may jointly indicate performing the above two kinds of processing on the first data, or may separately indicate whether to perform the above two kinds of processing on the first data. For example, the first information uses different values of a parameter to indicate transmitting a portion of the first data and not performing retransmission on the first data, or transmitting all of the first data and performing retransmission on the first data. For another example, the first information uses two parameters to indicate whether to transmit a portion of the first data and whether to perform retransmission on the first data. As an example, the first information uses a parameter to indicate transmitting a portion of the first data and another parameter to indicate performing retransmission on the first data. As another example, the first information uses a parameter to indicate transmitting all of the first data, and another parameter to indicate not performing retransmission on the first data.

In some embodiments, whether the terminal device performs the first processing on the first data may be determined based on the usage conditions. For example, the terminal device may determine whether to perform the first processing on the first data based on whether the uplink resources are sufficient or the status of the uplink load. As an example, if the uplink resources are sufficient or the uplink load is small, the terminal device does not perform the first processing on the first data. As another example, if the uplink resources are insufficient or the uplink load is heavy, the terminal device performs the first processing on the first data.

In some embodiments, the terminal device may determine whether to perform the first processing on the first data based on protocol predefined information.

In some embodiments, the terminal device may determine whether to perform the first processing on the first data based on first information. For example, the terminal device receives the first information from the network device, or the network device transmits the first information to the terminal device. In some embodiments, not performing retransmission on the first data may include various situations. For example, HARQ retransmission is not performed on the first data. As another example, HARQ retransmission and radio link control (RLC) retransmission are not performed on the first data. For another example, HARQ retransmission, RLC retransmission and packet data convergence layer Protocol (PDCP) retransmission are not performed on the first data.

In some embodiments, configuration granularity of the first information may be one or more of data service type (such as haptic data) granularity, data radio bearer (DRB) granularity, data flow granularity and data packet granularity. For example, the first information is configured to indicate that HARQ retransmission is not performed for the haptic data. As another example, the first information is configured to indicate that HARQ retransmission is not performed for DRB X or Flow X.

In order to ensure the user experience, the first information may be configured to indicate that retransmission is not performed on a portion of the haptic data. For example, the first information is configured to configure that retransmission is not performed for a first data packet. In this case, the terminal device may perform retransmission for a second data packet. The first data packet and the second data packet are both data packets of a haptic data group. As an example, the second data packet may be a relatively important data packet, such as a data packet containing a large amount of information, or a data packet with a great impact on the user experience. In some embodiments, the terminal device may determine the data packet to be retransmitted and/or the data packet not to be retransmitted, such as the first data packet and/or the second data packet, through a notification of an application layer.

In some embodiments, the configuration modes of the first information may include explicit configuration and implicit configuration. Taking HARQ retransmission as an example, the configuration mode of the first information is described below.

For example, the first information is explicitly indicated by an enumeration variable. As an example, if the network device configures the DRB characteristic as an enumeration variable “No transmission”, the DRB does not require HARQ retransmission. If the network device does not configure the parameter, the DRB requires HARQ retransmission.

For another example, the first information is implicitly indicated by a Boolean variable. The value of the Boolean variable may be true (“1”) or false (“0”). As an example, when the value of the Boolean variable corresponding to DRB is true, it means that the DRB does not require HARQ retransmission. When the value of the Boolean variable corresponding to DRB is false, it means that the DRB requires HARQ retransmission.

In some embodiments, the terminal device receives second information transmitted by the network device, or the network device transmits second information to the terminal device. The second information is configured to indicate that the first resource is used for transmitting the first data, and the first resource is an uplink transmission resource allocated by the network device to the terminal device. In other words, the network device may allocate uplink transmission resources for transmitting the first data to the terminal device, that is, the network device may allocate uplink transmission resources for transmitting data without performing HARQ retransmission to the terminal device.

The allocation of uplink radio resources includes various methods, such as dynamic allocation method and semi-static allocation method. According to different allocation methods of uplink radio resources, the second information may be carried in different information. For example, the second information may be carried in downlink control information (DCI) or a radio resource control (RRC) message.

In some embodiments, the second information may be carried in a message for the network device to allocate the first resource. For example, if the network device allocates the first resource to the terminal device through an RRC message, the network device may notify the terminal device through the RRC message that the first resource is used for transmitting the first data. If the network device allocates the first resource to the terminal device through DCI, the network device may notify the terminal device through the DCI that the first resource is used for transmitting the first data.

Based on the dynamic allocation method, the network device may allocate the first resource to the terminal device through the DCI. In this case, the second information may be carried in the DCI. The semi-static allocation method may include type 1 configured grant (CG) method and type 2 semi-persistent scheduling (SPS) method. In the type 1 CG method, the network device may allocate the first resource to the terminal device through the RRC message. In this case, the network device may notify the terminal device through RRC message that the first resource is used for transmitting the first data. In the type 2 SPS method, the network device may allocate the first resource to the terminal device through the RRC message and the DCI. In this case, the network device may notify the terminal device through the RRC message and the DCI that the first resource is used for transmitting the first data.

In some embodiments, the first resource may be a portion of the resources (referred to as second resources) allocated by the network device to the terminal device. Taking allocating the second resource by the type 1 CG method as an example, the second information is configured to indicate a portion of the second resource, such as radio resource in the second resource with odd system frame number (SFN) (that is, the first resource) for transmitting the first data.

In some embodiments, the configuration granularity of the second information may be one or more of data service type (such as haptic data) granularity, DRB granularity, data flow granularity and data packet granularity. For example, the second information is configured to instruct the terminal device to transmit the first data using the first resource. For another example, the second information is configured to instruct the terminal device to transmit data of the DRB X or the flow X using the first resource. The DRB X or the flow X is associated with the first data, or the data carried in the DRB X or the flow X is the first data.

In some embodiments, if a data amount of the first data is less than a transmission capacity of the first resource, the terminal device may add padding bits to remaining resources of the first resource. In other embodiments, if a data amount of the first data is less than a transmission capacity of the first resource, the terminal device may use remaining resources in the first resource to transmit other data except the first data, which is beneficial to avoiding resource waste.

In some embodiments, the terminal device may determine the usage mode of the remaining resources in the first resource based on the configuration information or the protocol predefined information of the network device, which facilitates implementation. In other embodiments, the terminal device may select the usage mode of the remaining resources in the first resource according to the situation. For example, when resources are insufficient, the remaining resources in the first resource may be used to transmit other data. When resources are sufficient, padding bits may be added to the remaining resources in the first resource. For another example, the terminal device may randomly determine the usage mode of the remaining resources in the first resource.

As mentioned above, in the process of processing the haptic data, the wireless network generally packs and transmits multiple haptic data to the network device at the transmission timing. However, the downlink feedback of the network device is generated based on the latest haptic data. Therefore, a portion of the multiple haptic data packed and transmitted to the network device may be useless to the network device. Based on this, in the embodiments of the present disclosure, the first processing may include transmitting a portion of the first data (i.e., the second data), which is beneficial to avoiding transmitting useless data to the network device, thereby saving resources for transmitting the useless data.

Since the shorter the time interval between the generation moment of the haptic data and the generation moment of the downlink feedback for the haptic data, the better the user experience, in some embodiments, the second data is the latest data obtained from the first data, which is beneficial to improving the user experience. The latest data obtained from the first data may be understood as the data with the sampling moment closest to the current moment in the first data.

For example, the second data is determined based on the generation moment of the data packet. The method of determining the second data based on the generation moment of the data packet is related to the method in which the terminal device generates the data packet. If the data packets are packed and transmitted in a first-in-first-out manner, that is, the data that enters the buffer first is packed and transmitted first. In this case, the second data includes data in N data packets with a latest generation moment. As an implementation, the data packets of the haptic service are packed and transmitted in a last-in-first-out manner, that is, the data that later enters the buffer is packed and transmitted first, so that network device can acquire the latest haptic data in time. In this case, the second data includes data in N data packets with an earliest generation moment. N is a positive integer greater than or equal to 1.

As an example, the N data packets may include untransmitted data packets in the first data. As another example, the N data packets may include transmitted data packets and untransmitted data packets in the first data, that is, regardless of whether the N data packets is transmitted before.

The above N may be configured by the network device. For example, the network device configures the value of N based on the network quality. For example, when the network quality is poor, the value of N is small, and when the network quality is good, the value of N is large, which is beneficial to ensuring that the network device can receive sufficient haptic data reliably and timely. For another example, the network device may blindly configure the value of N, so as to facilitate implementation.

The above N may be configured by the application server to the application layer of the terminal device through a notification of the application layer. When the application layer of the terminal device receives the configuration, it can notify N to the access layer of the terminal device.

The above N may be determined by the terminal device. For example, the terminal device may determine N according to the size of the uplink transmission resources. As an example, if the available uplink transmission resources of the terminal device accommodate B data packets, the value of N is less than or equal to B, for example, the value of N is B.

The importance of different haptic data may be different. Based on the importance of the haptic data, the priorities of data packets of the haptic service may be different. For example, data packets with higher importance have higher priorities. For example, in the haptic data, the priority of the data packet with initial encoding is higher than the priority of the data packet with differential encoding. The loss of data packets with initial encoding may have a greater impact on the user experience, and the loss of data packets with differential encoding may have a smaller impact on the user experience.

Based on this, the second data may be the data with higher priority in the first data. In other words, the priority of a data packet associated with the second data is higher than the priorities of data packets associated with other data in the first data except the second data.

In some embodiments, the priority of the first data may be determined by the application layer of the terminal device, or the application layer of the terminal device indicates the second data. For example, since the haptic data is encoded by the application layer of the terminal device, the application layer of the terminal device can determine the second data based on the encoding mode of the haptic data, thereby indicating the second data to the access layer of the terminal device.

As mentioned above, the second data may be determined based on the generation moment of the data packet and the priority of the data packet. For example, the second data may include data with higher priority in the first data and C data packets with the latest generation moment in the first data. C is a positive integer greater than or equal to 1. As an example, the value of C is 1. In this way, the downlink feedback of the network device can give consideration to reliability and timeliness.

In some embodiments, if (M-1) consecutive data packets in the first data are discarded or fail to transmit, the second data includes data in a Mth data packet. In other words, in this case, the terminal device preferentially transmits the Mth data packet, or increases the priority of the Mth data packet. Where M is a positive integer greater than or equal to 1. The value of M may be configured by the network device or indicated by the application layer of the terminal device.

Determining the second data in one or more of the above methods is beneficial to ensuring the quality of service (QoS) of the haptic service.

In some embodiments, if the HARQ transmission corresponding to the second data is unsuccessful, the terminal device may retransmit the second data through the next uplink radio resource. It should be noted that the retransmission of the second data mentioned herein is not a retransmission of a transport block (TB), but a retransmission of a data packet. The terminal device needs to reorganize a new TB, that is, the retransmission of the second data mentioned herein belongs to a new HARQ transmission.

As mentioned above, the terminal device may transmit the portion of the first data to the network device. The terminal device may discard or not transmit the data in the first data except the second data, or after a period of time, the terminal device discards the data in the first data except the second data. Discarding mentioned herein may be replaced by deleting, clearing, etc.

In some embodiments, in response to completing the transmission of the first data, the terminal device clears the buffer of a first HARQ process. The first HARQ process is a HARQ process for transmitting the first data. If the terminal device only transmits the portion of the first data (such as the second data) and discards or does not transmit other data, then in response to completing the transmission of the second data, the terminal device clears the buffer of the first HARQ process. The first HARQ process is a HARQ process for transmitting the second data.

In some embodiments, after the terminal device transmits the first data, if the network device allocates an uplink transmission resource (referred to as a third resource) for the terminal device and schedules the terminal device to use the first HARQ process for data transmission, the terminal device may consider that the allocated uplink transmission resource is used for the initial data transmission, not for the HARQ retransmission, or in other words, the terminal device may use the third resource for the initial data transmission. The first HARQ process is a HARQ process for transmitting the first data. In this case, the terminal device may use the third resource for initial data transmission regardless of the value of the new data indicator (NDI) corresponding to the DCI for allocating the third resource.

As mentioned above, the Nth data packet indicates that the leftward force is increased by 1 Newton on the basis of the (N-1)th data packet. However, if the network device does not receive the (N-1)th data packet, it will lead to the misunderstanding of the Nth data packet. In order to solve the problem, in the encoding of the haptic data, the encoding mode of the Nth data packet may be determined based on whether the previously transmitted data packet, such as the (N-1)th data packet, is successfully transmitted. For example, the (N-1)th data packet indicates that the leftward force is increased by 1 Newton, and the Nth data packet indicates that the leftward force is increased by 1 Newton on the existing basis (that is, on the basis of the content indicated by the (N-1)th data packet). If the transmission of the (N-1)th data packet is successful, the Nth data packet may indicate that the left force is increased by 1 Newton on the existing basis. In other words, the encoding result of the Nth data packet is an additional 1 Newton, and the final result is a total increase of 2 Newton. If the transmission of the (N-1)th data packet is unsuccessful, the Nth data packet needs to indicate that the leftward force is increased by 2 Newton on the existing basis (for example, on the basis of the content indicated by the (N-2)th data packet). In other words, the encoding result of the Nth data packet is an additional 2 Newton, and the final result can reach a total increase of 2 Newton.

It can be seen that the encoding results of the Nth data packet are different depending on whether the (N-1)th data packet is successfully transmitted or not. That is, the above method needs to determine the encoding mode of the current data packet based on the transmission result of the haptic data packet. Therefore, a transmission feedback mechanism for the haptic data is provided according to the embodiments of the present disclosure, so as to assist the above encoding mode.

In some embodiments, the terminal device may determine whether the first data is successfully transmitted based on one or more of the following: first indication information, and whether a first HARQ process is scheduled for use. The first indication information is configured to indicate whether the first data is successfully transmitted, and the first HARQ process is a HARQ process for transmitting the first data.

For example, the terminal device receives the first indication information transmitted by the network device, or the network device transmits the first indication information to the terminal device. The network device may transmit the first indication information to the terminal device based on decoding result of the first data. As an example, the network device may transmit the first indication information to the terminal device for each uplink transmission of the first data. As another example, in order to save transmission resources, if the network device correctly decodes the received first data, it does not transmit the first indication information to the terminal device. If the network device fails to decode the first data, it transmits the first indication information to the terminal device.

Optionally, the first indication information is carried in a physical layer message or a media access control element (MAC CE).

For another example, if the first HARQ process is scheduled for initial data transmission within a first time period, the first data is successfully transmitted. If the first HARQ process is not scheduled for initial data transmission within the first time period, the first data is unsuccessfully transmitted. That is, if the network device schedules the terminal device to use the first HARQ process for initial data transmission within the first time period, the first data is successfully transmitted. If the network device does not schedule the terminal device to use the first HARQ process for initial data transmission within the first time period, the first data is unsuccessfully transmitted.

For another example, if the first HARQ process is scheduled for data retransmission within a second time period, the first data is unsuccessfully transmitted. If the first HARQ process is not scheduled for data retransmission within the second time period, the first data is successfully transmitted.

Whether the first HARQ process is scheduled for retransmission or new transmission may be determined based on NDI.

It should be noted that the second time period may be the same as or different from the first time period, which is not limited by the present disclosure.

It should be noted that the network device schedules the terminal device to use the first HARQ process for data retransmission, which is only used to notify the terminal device that “the encoding of the last uplink data failed”, and is not used to notify the terminal device to perform HARQ retransmission.

In some embodiments, the access layer of the terminal device transmits third information to the application layer of the terminal device, and the third information is configured to indicate whether the first data is successfully transmitted. In this way, the application layer can determine the encoding mode of the haptic data packet based on the third information. The third information may be determined based on the first indication information, or may be determined based on whether the first HARQ process is scheduled for use.

For example, regardless of whether the first data is successfully transmitted, the access layer of the terminal device transmits the third information to the application layer of the terminal device.

For another example, the access layer of the terminal device may only transmit a notification of successful transmission of the first data to the application layer of the terminal device. In this case, if the application layer of the terminal device receives the third information, such as receiving the third information within a third time period, it is considered that the first data is successfully transmitted. If the application layer of the terminal device does not receive the third information, such as not receiving the third information within the third time period, it is considered that the first data is unsuccessfully transmitted.

For another example, the access layer of the terminal device may only transmit the notification of unsuccessful transmission of the first data to the application layer of the terminal device. In this case, if the application layer of the terminal device receives the third information, such as receiving the third information within the third time period, it is considered that the first data is unsuccessfully transmitted. If the application layer of the terminal device does not receive the third information, such as not receiving the third information within the third time period, it is considered that the first data is successfully transmitted.

In some embodiments, the third information may be configured to indicate whether a portion of the first data (referred to as third data) is successfully transmitted, that is, the terminal device may only notify the application layer whether the third data is successfully transmitted. The third data may be determined by the application layer and notified to the access layer of the terminal device.

In some embodiments, the third data may be determined based on the importance of the haptic data. The third data is, for example, a data packet with initial encoding or a data packet containing a large amount of information. As an example, if the (N-1)th data packet indicates that the leftward force is increased by 1 Newton on the existing basis, and the Nth data packet indicates that the leftward force is increased by 6 Newton on the existing basis, the Nth data packet contains more information than the (N-1)th data packet.

The third data may be the same as or different from the second data. For example, the third data may be a portion of the second data.

In some embodiments, the application layer of the terminal device may determine the encoding mode of the subsequent data packet based on the third information, which is beneficial to the correct encoding of the haptic data.

In some embodiments, the data packet associated with the first data, that is, the data packet of the haptic service, may not have PDCP sequence number (SN) and/or RLC SN. When media access control (MAC) packetizes, the terminal device may packetize according to the order in which the first data arrives at the access layer of the terminal device, that is, the data that arrives at the access layer of the terminal device first is placed in the front of TB, and the data that arrives at the access layer of the terminal device late is placed behind TB. Accordingly, the network device may submit to the node of the next network device according to the sequence of MAC service data units (SDU) in the received TB.

In some embodiments, the terminal device may count the data transmission of the haptic service. Statistical results may include, for example, the number and identifiers of “packets successfully transmitted”, “packets unsuccessfully transmitted” and “packets directly discarded without transmission”. The terminal device may report the above statistical results to the network device through processes such as quality of experience (QoE), so as to improve the user experience.

In some embodiments, when a handover of the service cell of the terminal device occurs, the terminal device does not retransmit the data packet of the haptic service to the target cell. Since the downlink feedback of the haptic service is always generated based on the latest data, and the part of data packets is useless to the network device after the cell handover. In this case, not retransmitting the data packets of the haptic service is beneficial to saving transmission resources.

The method provided by the embodiments of the present disclosure can avoid meaningless retransmission of the haptic data, so that the terminal device can always transmit the latest data. In addition, in the embodiments of the present disclosure, the terminal device only transmits a portion of the haptic data, which can reduce the uplink load of the network on the basis of meeting the QoS requirements.

The method embodiments of the present disclosure have been described in detail above. The device embodiments of the present disclosure will be described in detail below. It should be understood that the descriptions of the device embodiments correspond to the description of the method embodiments. Therefore, for the parts that are not described in detail, reference may be made to the previous method embodiments.

FIG. 5 is a schematic structural diagram of a terminal device provided by some embodiments of the present disclosure. The terminal device 500 includes an acquisition unit 510.

The acquisition unit 510 is configured to acquire first information. The first information is configured to instruct the terminal device to perform a first processing on first data, the first data is first-type data, and the first processing includes: transmitting a portion of the first data; and/or not performing retransmission on the first data.

In some embodiments, the first-type data is haptic data.

In some embodiments, not performing retransmission on the first data includes at least one of the following: not performing hybrid automatic repeat-request (HARQ) retransmission on the first data, not performing HARQ retransmission and radio link control (RLC) retransmission on the first data, and not performing HARQ retransmission, RLC retransmission, and packet data convergence protocol (PDCP) retransmission on the first data.

In some embodiments, the device further includes: a receiving unit, configured to receive second information transmitted by a network device. The second information is configured to indicate that first resources are used for transmitting the first data, and the first resources are uplink transmission resources allocated by the network device to the terminal device.

In some embodiments, the second information is carried in downlink control information (DCI) or a radio resource control (RRC) message.

In some embodiments, the device further includes: a processing unit, configured to, in response to a data amount of the first data being less than a transmission capacity of the first resources, use remaining resources in the first resources to transmit other data except the first data, or add padding bits to remaining resources of the first resources.

In some embodiments, the portion of the first data is second data, and the second data is determined based on a generation moment of data packets, and/or, a priority of data packets.

In some embodiments, the second data includes data in N data packets with a latest generation moment in the data packets. N is a positive integer greater than or equal to 1.

In some embodiments, a priority of data packets associated with the second data is higher than priorities of data packets associated with other data except the second data in the first data.

In some embodiments, in response to (M-1) consecutive data packets being discard or being unsuccessfully transmitted, the second data includes data in a Mth data packet, where M is a positive integer greater than or equal to 1.

In some embodiments, the terminal device determines whether the first data is successfully transmitted based on at least one of the following: first indication information, and whether a first HARQ process is scheduled for use. The first indication information is configured to indicate whether the first data is successfully transmitted, and the first HARQ process is a HARQ process for transmitting the first data.

In some embodiments, the terminal device determining whether the first data is successfully transmitted based on whether a first HARQ process is scheduled for use, includes: in response to the first HARQ process being scheduled for initial data transmission within a first time period, determining that the first data is successfully transmitted, or in response to the first HARQ process not being scheduled for initial data transmission within a first time period, determining that the first data is unsuccessfully transmitted.

In some embodiments, the terminal device determining whether the first data is successfully transmitted based on whether a first HARQ process is scheduled for use, includes: in response to the first HARQ process being scheduled for data transmission within a second time period, determining that the first data is unsuccessfully transmitted, or in response to the first HARQ process not being scheduled for data transmission within a second time period, determining that the first data is successfully transmitted.

In some embodiments, the device further includes: a transmitting unit, configured for an access layer of the terminal device to transmit third information to an application layer of the terminal device. The third information is configured to indicate whether the first data is successfully transmitted.

FIG. 6 is a schematic structural diagram of a network device provided by some embodiments of the present disclosure. The network device 600 includes a first transmitting unit 610.

The first transmitting unit 610 is configured to transmit first information to a terminal device. The first information is configured to instruct the terminal device to perform a first processing on first data, the first data is first-type data, and the first processing includes: transmitting a portion of the first data, and/or not performing retransmission on the first data.

In some embodiments, the first-type data is haptic data.

In some embodiments, not performing retransmission on the first data includes at least one of the following: not performing hybrid automatic repeat-request (HARQ) retransmission on the first data, not performing HARQ retransmission and radio link control (RLC) retransmission on the first data, and not performing HARQ retransmission, RLC retransmission, and packet data convergence protocol (PDCP) retransmission on the first data.

In some embodiments, the device further includes: a second transmitting unit, configured to transmit second information to the terminal device. The second information is configured to indicate that first resources are used for transmitting the first data, and the first resources are uplink transmission resources allocated by the network device to the terminal device.

In some embodiments, the second information is carried in downlink control information (DCI) or a radio resource control (RRC) message.

In some embodiments, the portion of the first data is second data, and the second data is determined based on a generation moment of data packets, and/or, a priority of data packets.

In some embodiments, the second data includes data in N data packets with a latest generation moment in the data packets. N is a positive integer greater than or equal to 1.

In some embodiments, a priority of data packets associated with the second data is higher than priorities of data packets associated with other data except the second data in the first data.

In some embodiments, in response to (M-1) consecutive data packets being discard or being unsuccessfully transmitted, the second data includes data in a Mth data packet. M is a positive integer greater than or equal to 1.

In some embodiments, the device further includes: a third transmitting unit, configured to transmit first indication information to the terminal device. The first indication information is configured to indicate whether the first data is successfully transmitted.

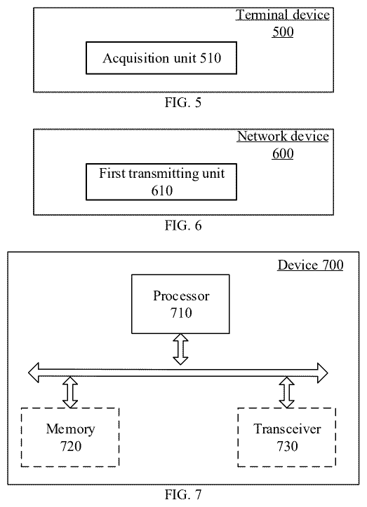

In some alternative embodiments, the transmitting unit and the receiving unit described above may be a transceiver 730, the processing unit may be a processor 710, and the terminal device 500 and the network device 600 may further include a memory 720, as shown in FIG. 7.

FIG. 7 is a schematic structural diagram of a communication device according to some embodiments of the present disclosure. The dashed lines in FIG. 7 indicate that the units or modules are optional. The device 700 may be used to implement the method described in the above method embodiments. The device 700 may be a chip, a terminal device or a network device.

The device 700 may include one or more processors 710. The one or more processors 710 may support the device 700 to implement the method described in the above embodiments. The one or more processors 710 may be a general-purpose processor or a special-purpose processor. For example, the processor is a central processing unit (CPU). Alternatively, the processor may be other general-purpose processor, a digital signal processor (DSP), an application specific integrated circuits (ASIC), a field programmable gate array (FPGA) or other programmable logic device, a discrete gate or a transistor logic device, a discrete hardware component, etc. The general-purpose processor may be a microprocessor or the processor may be any conventional processor, etc.

The device 700 further includes one or more memories 720 storing a program. The program is executed by the processor 710 to perform the method described in the above embodiments. The memory 720 is independent of or integrated in the processor 710.

The device 700 further includes a transceiver 730. The processor 710 communicates with other devices or chips via the transceiver 730. For example, the processor 710 transmits and receives data with other devices or chips via the transceiver 730.

A computer-readable storage medium configured to store a program is provided according to some embodiments of the present disclosure. The computer-readable storage medium is applicable to the terminal device or the network device according to the embodiments of the present disclosure, and the program causes the computer to perform the method implemented by the terminal device or the network device according to the embodiments of the present disclosure.

A computer program product is provided according to some embodiments of the present disclosure. The computer program product includes a program. The computer program product is applicable to the terminal device or the network device according to the embodiments of the present disclosure, and the program causes the computer to perform the method implemented by the terminal device or the network device according to the embodiments of the present disclosure.

A computer program is further provided according to some embodiments of the present disclosure. The computer program may be applied to the terminal device or the network device according to the embodiments of the present disclosure, and the computer program causes a computer to execute the method implemented by the terminal device or the network device according to the embodiments of the present disclosure.

It should be noted that, the terms “system” and “network” in the embodiments of the present disclosure may be used interchangeably. In addition, the terms used in the present disclosure are only used to explain the specific embodiment of the present disclosure, and are not intended to limit the present disclosure. The terms “first”, “second”, “third”, and “fourth” used to are used to distinguish between different objects and are not intended to describe a particular order. In addition, the terms “include” and “have”, and any variations thereof, are intended to cover non-exclusive inclusion.

In the embodiments of the present disclosure, the term “indicate” may be a direct indication, an indirect indication, or an association relationship. For example, A indicating B, which can mean that A indicates B directly, for example, B can be obtained through A, or it can mean that A indicates B indirectly, for example, A indicates C, and B can be obtained through C; or it can mean that there is an association between A and B.

In the embodiments of the present disclosure, the term “include” may refer to direct inclusion or indirect inclusion. Optionally, “include” mentioned in the embodiments of the present disclosure may be replaced by “indicate” or “configured to determine”. For example, A including B can be replaced by A indicating B, or A being configured to determine B.

In the embodiments of the present disclosure, “B corresponding to A” means that B is associated with A, and B can be determined according to A. However, it should be noted that determining B according to A does not mean determining B only according to A, but also according to A and/or other information.

In the embodiments of the present disclosure, the term “correspond” can indicate a direct or indirect corresponding relationship between the two, or an associative relationship between the two, or a relationship between indicating and being indicated, or configuring and being configured, and the like.

In the embodiments of the present disclosure, “pre-define” or “pre-configured” can be implemented by pre-saving corresponding codes, tables, or other means that can be used to indicate relevant information in devices (such as terminal devices and network devices), which is not limited by the present disclosure. For example, pre-defined can refer to being defined in a protocol.

In the embodiment of the present disclosure, the “protocol” can be a standard protocol in the communication field, including, for example, LTE protocol, NR protocol and related protocols applied in future communication systems, which is not limited by the present disclosure.

In the embodiments of the present disclosure, the term “and/or” is only an association relationship describing the associated objects, which means that there can be three relationships. For example, A and/or B, which can mean that there are three situations: A alone, A and B, and B alone. In addition, the character “/” herein generally indicates an “or” relationship between the associated objects.

In the embodiments of the present disclosure, the magnitude of the reference numerals of the above processes does not imply the order of execution, and the order of execution of the processes should be determined by its function and inherent logic, and should not constitute any limitation on the implementation process of the embodiments of the present disclosure.

In the embodiments of the present disclosure, it should be understood that the disclosed system, device and method can be realized in other ways. For example, the embodiments for the device described above are only schematic. For example, the division of the units is only a logical function division. In actual implementation, there may be other division methods, such as a plurality of units or components can be combined or integrated into another system, or some features can be ignored or not implemented. In addition, the coupling or direct coupling or communication connection shown or discussed can be indirect coupling or communication connection through some interfaces, devices or units, which can be electrical, mechanical or other forms.

The units described as separate components may or may not be physically separated, and the components displayed as units may or may not be physical units, that is, they may be located in one place or distributed to multiple network units. A portion or all of the units can be selected according to actual needs to achieve the purpose of the embodiments of the present disclosure.

In addition, each respective functional unit in the embodiments of the present disclosure can be integrated into one processing unit, or each respective unit can exist physically, or two or more units can be integrated into one unit.

Through the description of the above embodiments, the above method embodiments can be implemented by means of software, hardware, firmware, or any combination thereof. In case of being implemented in software, it can be fully or partially implemented in the form of a computer program product. The computer program product includes one or more computer instructions. When the computer program instructions are loaded and executed on a computer, the flow or function described in the embodiment of the present disclosure is generated in whole or in part. The computer can be a general-purpose computer, a special-purpose computer, a computer network, or other programmable devices. The computer instructions can be stored in a computer-readable storage medium or transmitted from one computer-readable storage medium to another computer-readable storage medium. For example, the computer instructions can be transmitted from a website, a computer, a server or a data center to a website, computer, server or data to another website site, computer, server, or data center through wired (such as coaxial cable, optical fiber, digital subscriber line (DSL)) or wireless (such as infrared, wireless, microwave, etc.). The computer-readable storage medium can be any available medium that a computer can read or a data storage device such as a server, data center, etc. which contains one or more available media integration. The available medium may be a magnetic medium such as a floppy disk, a hard disk, a magnetic tape, etc., or an optical medium such as a digital video disc (DVD) or a semiconductor medium such as a solid state disk (SSD), etc.

The above is only the specific embodiments of the present disclosure, but the protection scope of the present disclosure is not limited thereto. Any variations or substitutions that can be easily conceived by those skilled in the art within the technical scope disclosed by the present disclosure, should be included in the protection scope of the present disclosure. Therefore, the protection scope of the present disclosure should be based on the protection scope of the claims.

What is claimed is:

1. A data transmission method, comprising:
acquiring, by a terminal device, first information, wherein the first information is configured to instruct the terminal device to perform a first processing on first data, the first data is first-type data, and the first processing comprises at least one of:
transmitting a portion of the first data; or
not performing retransmission on the first data.

2. The method according to claim 1, wherein the first-type data is haptic data.

3. The method according to claim 1, wherein not performing retransmission on the first data includes at least one of the following:
not performing hybrid automatic repeat-request (HARQ) retransmission on the first data;
not performing HARQ retransmission and radio link control (RLC) retransmission on the first data; or
not performing HARQ retransmission, RLC retransmission, and packet data convergence protocol (PDCP) retransmission on the first data.

4. The method according to claim 1, further comprising:
receiving, by the terminal device, second information from a network device, wherein the second information indicates that first resources are used for transmitting the first data, and the first resources are uplink transmission resources allocated by the network device to the terminal device.

5. The method according to claim 4, wherein the second information is carried in downlink control information (DCI) or a radio resource control (RRC) message.

6. The method according to claim 4, further comprising:
in response to a data amount of the first data being less than a transmission capacity of the first resources, using, by the terminal device, remaining resources in the first resources to transmit other data except the first data; or adding, by the terminal device, padding bits to remaining resources of the first resources.

7. The method according to claim 1, wherein the portion of the first data is second data, and the second data is determined based on at least one of a generation moment of data packets or a priority of data packets.

8. The method according to claim 7, wherein the second data includes data in N data packets with a latest generation moment in the data packets, wherein N is a positive integer greater than or equal to 1.

9. The method according to claim 7, wherein a priority of data packets associated with the second data is higher than priorities of data packets associated with other data except the second data in the first data.

10. The method according to claim 7, wherein in response to (M-1) consecutive data packets being discard or being unsuccessfully transmitted, the second data includes data in a Mth data packet, wherein M is a positive integer greater than or equal to 1.

11. The method according to claim 1, wherein the terminal device determines whether the first data is successfully transmitted based on at least one of the following:
first indication information; or
whether a first HARQ process is scheduled for use;
wherein the first indication information indicates whether the first data is successfully transmitted, and the first HARQ process is a HARQ process for transmitting the first data.

12. The method according to claim 11, wherein the terminal device determining whether the first data is successfully transmitted based on whether a first HARQ process is scheduled for use comprises:
in response to the first HARQ process being scheduled for initial data transmission within a first time period, determining that the first data is successfully transmitted; or
in response to the first HARQ process not being scheduled for initial data transmission within a first time period, determining that the first data is unsuccessfully transmitted.

13. The method according to claim 11, wherein the terminal device determining whether the first data is successfully transmitted based on whether a first HARQ process is scheduled for use comprises:
in response to the first HARQ process being scheduled for data transmission within a second time period, determining that the first data is unsuccessfully transmitted; or
in response to the first HARQ process not being scheduled for data transmission within a second time period, determining that the first data is successfully transmitted.

14. The method according to claim 11, further comprising:
transmitting, by an access layer of the terminal device, third information to an application layer of the terminal device, wherein the third information indicates whether the first data is successfully transmitted.

15. A data transmission method, comprising:
transmitting, by a network device, first information to a terminal device, wherein the first information is configured to instruct the terminal device to perform a first processing on first data, the first data is first-type data, and the first processing includes at least one of:
transmitting a portion of the first data; or
not performing retransmission on the first data.

16. The method according to claim 15, wherein the first-type data is haptic data.

17. The method according to claim 15, wherein not performing retransmission on the first data includes at least one of the following:
not performing hybrid automatic repeat-request (HARQ) retransmission on the first data;
not performing HARQ retransmission and radio link control (RLC) retransmission on the first data; or
not performing HARQ retransmission, RLC retransmission, and packet data convergence protocol (PDCP) retransmission on the first data.

18. The method according to claim 15, further comprising:
transmitting, by the network device, second information to the terminal device, wherein the second information indicates that first resources are used for transmitting the first data, and the first resources are uplink transmission resources allocated by the network device to the terminal device.

19. The method according to claim 18, wherein the second information is carried in downlink control information (DCI) or a radio resource control (RRC) message.

20. The method according to claim 15, wherein the portion of the first data is second data, and the second data is determined based on at least one of a generation moment of data packets or a priority of data packets.
